(19) United States
(12) Patent Application Publication
(10) Pub. No.: US 2024/0254271 A1
(43) Pub. Date: Aug. 1, 2024

(54) LIQUID MONOFUNCTIONAL 1,3-DIOXOLANE COPOLYMERS

(71) Applicant: WACKER CHEMIE AG, Munich (DE)

(72) Inventors: Theresa Dellermann, München (DE); Laura Ascherl, Olching (DE); Martina Baumann, Sauerlach (DE)

(73) Assignee: Wacker Cheimie AG, Munich (DE)

(21) Appl. No.: 18/565,260

(22) PCT Filed: May 31, 2021
(86) PCT No.: PCT/EP2021/064570

§ 371 Date: Nov. 29, 2023

(51) Int. Cl. C08G 4/00

(52) U.S. Cl. CPC C08G 4/00

(57) ABSTRACT

1,3-Dioxolane copolymers and methods of producing the same. Where the 1,3-Dioxolane copolymers have a general formula I

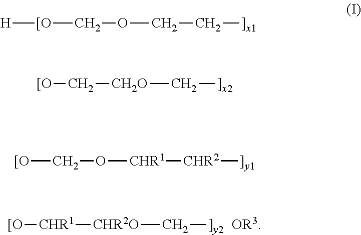

The invention relates to monofunctional 1,3-dioxolane copolymers of 1,3-dioxolane and alkyl-substituted 1,3-dioxolane and to a process for the production thereof.

The serious contribution of increased CO₂ emissions to climate change is undisputed, and it is not only since the signing of the Paris Climate Agreement that the reduction of CO₂ emissions has been an important factor for stopping the increase in the average global temperature.

Not insignificant amounts of CO₂ are emitted into the atmosphere also in the production of plastics; according to projections by the EIT Climate-KIC, by 2050 15-20% alone of global CO₂ emissions will be attributable to the production of plastics. One way to counter this trend is to utilize CO₂ in plastics production, and to integrate CO₂ into the value chain not as waste but as starting material.

In this context, polyacetals represent an attractive class of plastics, it being possible to produce them via the intermediate of cyclic acetals inter alia by catalytic fixing of CO₂ with green hydrogen.

However, conventional polyacetals, also called polyoxymethylenes (POM), such as those obtainable, for example, by polymerization of formaldehyde or trioxane (POM-H) or by ring-opening polymerization of 1,3-dioxolane (POM-C), are solid at room temperature since the polymers have crystalline subsections and an associated melting point, which, depending on the use, impedes further processing. The possibility of being able to prepare liquid representatives of this material class would significantly expand the scope of application of polyacetals.

Conventional polyoxymethylenes are terminated by alkyl groups during the synthesis. This results in the stabilization of the polymers, but at the same time a functionalization or further reaction is also prevented.

Equipping the polymers with further functional groups which enable polymer-analogous reactions at the polyacetal would likewise expand the range of applications of the materials, since it would be possible to transform them into attractive hybrid materials by way of simple organic reactions. Monofunctional polymers in particular have proven to be advantageous for the preparation of these hybrid materials, since they tend not to display crosslinking behavior.

Lutz et al., in “One-Step Synthesis of Bis-Macromonomers of Poly(1,3-dioxolane) Catalyzed by Maghnite-H⁺” J. Appl. Polym. Sci., Vol. 99, 3147-3152 (2006), describe the preparation of α,ω-bisfunctional polydioxolanes by acid-catalyzed ring-opening polymerization of 1,3-dioxolane in the presence of methacrylic anhydride. However this method does not make it possible to obtain either monofunctional or liquid products.

Goethals et al. “Polymer Networks Based on α,ω-Methacrylate-Terminated Poly(1,3-dioxolane)” Polym. Int., Vol. 38, 89-94 (1995) also describes a similar synthesis. Here, methylene-bis(oxyethylmethacrylate) participates in the initiation and chain-termination of an acid-catalyzed ring-opening polymerization of 1,3-dioxolane, the result of which being bisfunctional, α,ω-methacrylate-terminated, solid polydioxolane.

WO14095971 A2 describes the polymerization of trioxane and cyclic acetals starting with bifunctional polyols, the terminal OH groups of the polyacetal subsequently being terminated by means of glutaric anhydride to form carboxylic acid-terminated polymers. Solid products are obtained.

The object of the present invention was therefore to obtain monofunctional polyacetals which are liquid over a wide temperature range and can be produced from cyclic acetals.

The invention provides 1,3-dioxolane copolymers of the general formula I

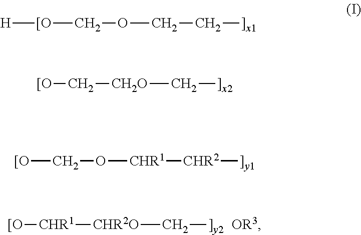

in which
x1+x2 has values of 10 to 2000,
R¹ and R² are hydrogen radicals or C₁ to C₁₈ alkyl radical, where in each case at least one radical R¹ or R² in the units [O—CH₂—O—CHR¹—CHR²-]_{y1} and [O—CHR¹—CHR²O—CH₂-]_{y2} is a C₁ to C₁₈ alkyl radical,
with the proviso that y1+y2 has values of 3*(x1+x2+y1+y2)/100 to 50*(x1+x2+y1+y2)/100,
R³ is an aliphatically saturated or unsaturated hydrocarbon radical which is unsubstituted or substituted by halogen atoms, amino groups, C₁₋₆ alkyl, C₁₋₆ alkoxy or silyl groups and has 1 to 100 carbon atoms, in which one or more mutually non-adjacent —CH₂ units may be replaced by —O—, —S—, C═O, —O—C(O)— or —NR⁴— groups and in which one or more mutually non-adjacent=CH units may be replaced by —N═ groups and
R⁴ is a hydrogen radical or C₁ to C₁₈ alkyl radical.

The 1,3-dioxolane copolymers of the general formula I are polyacetals.

The controlled incorporation of imperfections in the form of alkyl groups which protrude from the polymer backbone of the 1,3-dioxolane copolymers of the general formula I means that the crystallinity of the polyacetal is eliminated, not just reduced. Such amorphous behavior can be detected by way of differential scanning calorimetry measurements if there is only a glass transition point but no melting point.

The copolymers are formed from 1,3-dioxolane and 1,3-dioxolane substituted in the 4-position and/or 5-position. They are liquid over a wide temperature range and therefore of very good suitability for further processing.

They preferably have a glass transition between −50° C. and −70° C. and especially preferably have no melting point. The copolymers start to decompose at >100° C., in particular at >110° C.

The 1,3-dioxolane copolymers comprise the units [O—CH₂—O—CH₂—CH₂-]ₓ₁, [O—CH₂—CH₂O—CH₂-]ₓ₂, [O—CH₂—O—CHR¹—CHR²-]_{y1}, [O—CHR¹—CHR²O—CH₂-]_{y2}, randomly or in blocks.

Preferably x1+x2 has values of 20 to 1000, particularly preferably of 30 to 500, in particular of 50 to 300.

Examples of alkyl radicals R¹, R² and R⁴ are linear and branched alkyl radicals, such as the methyl, ethyl, i-octyl and n-octyl radical, and cycloalkyl radicals, such as the cyclohexyl radical. Preferably R¹, R² and R⁴, independently at each occurrence, are hydrogen radicals or C₁ to C₆ alkyl radicals, particularly preferably hydrogen radicals or methyl, ethyl, n-propyl or i-propyl radicals.

Preferably in each case only one radical R¹ or R² in the units [O—CH₂—O—CHR¹—CHR²-]_{y1} and [O—CHR¹—CHR²O—CH₂-]_{y2} is a C₁ to C₁₈ alkyl radical.

R³ has preferably 1 to 30, in particular 1 to 18, carbon atoms.

Examples of R³, which are an aliphatically saturated hydrocarbon radical, are alkyl radicals, such as the methyl, ethyl, n-propyl, isopropyl, n-butyl, sec-butyl, isobutyl, tert-butyl, n-pentyl, sec-pentyl, isopentyl, neopentyl and tert-pentyl radical; hexyl radicals, such as the n-hexyl radical; heptyl radicals, such as the n-heptyl radical; octyl radicals, such as the n-octyl radical, and isooctyl radicals, such as the 2,4,4-trimethylpentyl radical; nonyl radicals, such as the n-nonyl radical; decyl radicals, such as the n-decyl radical; dodecyl radicals, such as the n-dodecyl radical; hexadecyl radicals, such as the n-hexadecyl radical; octadecyl radicals, such as the n-octadecyl radical; cycloalkyl radicals, such as the cyclopentyl, cyclohexyl, cycloheptyl radical and methylcyclohexyl radical; aryl radicals, such as the phenyl, naphthyl, anthryl and phenanthryl radical; alkaryl radicals, such as the o-, m- and p-tolyl, xylyl, mesitylenyl and o-, m- and p-ethylphenyl radical; and alkaryl radicals, such as the benzyl radical, the α- and the pi-phenylethyl radical. In one preferred embodiment, R³ comprises an alkyl radical having 1 to 18 carbon atoms.

Examples of R³, which are an aliphatically unsaturated hydrocarbon radical, are alkenyl radicals and alkynyl radicals in which one or more mutually non-adjacent —CH₂ units may be replaced by —O— or —O—C(O)— groups. Preferred alkenyl radicals R³ have 2 to 10 carbon atoms, such as vinyl, allyloxyethyl, propyl methacrylate, butyl methacrylate, methallyl, 1-propenyl, 5-hexenyl, ethynyl, butadienyl, hexadienyl, cyclopentenyl, cyclopentadienyl, cyclohexenyl, acrylate and methacrylate, and particularly preferably are vinyl, allyl, acrylate, methacrylate, allyloxyethyl, propyl methacrylate and butyl methacrylate.

Preferred alkenyl radicals R³ are also polyethylene glycols having terminal alkenyl radicals.

Preferably y1+y2 has values of 5*(x1+x2+y1+y2)/100 to 40*(x1+x2+y1+y2)/100, particularly preferably values of 10*(x1+x2+y1+y2)/100 to 30*(x1+x2+y1+y2)/100, in particular values of 14*(x1+x2+y1+y2)/100 to 25*(x1+x2+y1+y2)/100.

The 1,3-dioxolane copolymers preferably have a molecular weight Mw of between 750-300 000, particularly preferably between 1500-125 000, very particularly preferably between 2200-63 000, in particular between 4000-25 000.

The 1,3-dioxolane copolymers preferably have a dynamic viscosity at 25° C. of between 50 mPas-500 Pas, particularly preferably between 500 mPas-200 Pas, in particular between 700 mPas-50 Pas.

The 1,3-dioxolane copolymers of the general formula I above can be produced in a simple manner and with short reaction times. As a result of the production, the 1,3-dioxolane copolymers of the general formula (I) above may also be mixed with fractions of copolymers in which, in the general formula (I), the radical R³ has been replaced by a hydrogen atom or the hydrogen atom at the other end of the 1,3-dioxolane copolymers has been replaced by a radical R³. Preferably, the copolymers of the general formula (I) above are mixed with at most 5 mol %, particularly preferably at most 1 mol %, in particular at most 0.1 mol %, of copolymers in which, in the general formula (I), the radical R³ has been replaced by a hydrogen atom or the hydrogen atom at the other end of the 1,3-dioxolane copolymers has been replaced by a radical R³.

The invention also provides a process for producing the 1,3-dioxolane copolymers of the general formula (I)

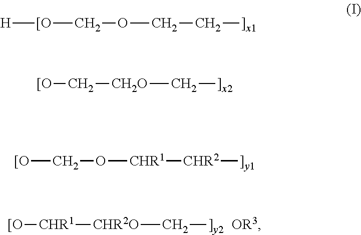

in which
x1+x2 has values of 10 to 2000,
R¹ and R² are hydrogen radicals or C₁ to C₁₈ alkyl radical, where in each case at least one radical R¹ or R² in the units [O—CH₂—O—CHR¹—CHR²-]_{y1} and [O—CHR¹—CHR²O—CH₂-]_{y2} is a C₁ to C₁₈ alkyl radical,
with the proviso that y1+y2 has values of 3*(x1+x2+y1+y2)/100 to 50*(x1+x2+y1+y2)/100,
R³ is an aliphatically saturated or unsaturated hydrocarbon radical which is unsubstituted or substituted by halogen atoms, amino groups, C₁₋₆ alkyl, C₁₋₆ alkoxy or silyl groups and has 1 to 100 carbon atoms, in which one or more mutually non-adjacent —CH₂ units may be replaced by —O—, —S—, C═O, —O—C(O)— or —NR⁴— groups and in which one or more mutually non-adjacent ═CH units may be replaced by —N═ groups and
R⁴ is a hydrogen radical or C₁ to C₁₈ alkyl radical,
in which process 1,3-dioxolane is copolymerized with alkyl-substituted 1,3-dioxolane of the general formula II

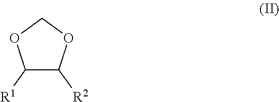

in the presence of a Lewis or Brønsted acid and an alcohol of the general formula R³OH, where the molar ratio of Lewis or Brønsted acid to alcohol of the general formula R³OH is less than 1.

In the general formula II, there are alkyl radicals R¹ and R² in the 4- and 5-position of the 1,3-dioxolanes.

The process is a ring-opening polymerization of the dioxolane monomers by way of cationically induced catalysis.

The catalyst is the Lewis or Brønsted acid. The alcohol R³OH has the function of an initiator.

In contrast to conventional methods, this process makes it possible to dispense with subsequent functionalization of an α,ω-hydroxy-terminated polymer.

In the process, preferably at least 10 mol %, particularly preferably at least 20 mol %, in particular at least 30 mol % of alkyl-substituted 1,3-dioxolane of the general formula II, based on the total amount of 1,3-dioxolane and alkyl-substituted 1,3-dioxolane of the general formula II, is used.

Since alkyl-substituted 1,3-dioxolane of the general formula II is less reactive than 1,3-dioxolane, it is necessary in the process to use more of it than is arithmetically necessary in order to achieve a certain proportion of values y1+y2.

Examples of acids are Lewis acids, such as BF₃, AlCl₃, TiCl₃, SnCl₄, SO₃, PCl₅, POCl₃, FeCl₃ and its hydrates and ZnCl₂; Brønsted acids, such as boric acid, tetrafluoroboric acid, nitric acid, nitrous acid, phosphoric acid, phosphorous acid, hypophosphorous acid, sulfuric acid, sulfurous acid, peroxysulfuric acid, hydrochloric acid, hydrofluoric acid, hydroiodic acid, hydrobromic acid, perchloric acid, hexafluorophosphoric acid, aluminum chloride, zinc chloride, benzenesulfonic acid, p-toluenesulfonic acid, methanesulfonic acid, trifluoromethanesulfonic acid and carboxylic acids, such as chloroacetic, trichloroacetic, acetic, acrylic, benzoic, trifluoroacetic, citric, crotonic, formic, fumaric, maleic, malonic, gallic, itaconic, lactic, tartaric, oxalic, phthalic and succinic acids, acidic ion exchangers, acidic zeolites, acid-activated bleaching earth and acid-activated carbon black.

Particular preference is given to trifluoromethanesulfonic acid.

The process preferably takes place in the absence of water. This suppresses the formation of copolymers in which, in the general formula (I), the radical R³ has been replaced by a hydrogen atom.

The process may be performed in the presence or in the absence of aprotic solvents. If aprotic solvents are used, preference is given to solvents or solvent mixtures with a boiling point or boiling range of up to 120° C. at 0.1 MPa. Examples of such solvents are ethers, such as dioxane, tetrahydrofuran, diethyl ether, methyl tert-butyl ether, diisopropyl ether, diethylene glycol dimethyl ether; chlorinated hydrocarbons, such as dichloromethane, trichloromethane, tetrachloromethane, 1,2-dichloroethane, trichloroethylene; hydrocarbons, such as pentane, n-hexane, hexane isomer mixtures, heptane, octane, benzine, petroleum ether, benzene, toluene, xylenes; siloxanes, particularly linear dimethylpolysiloxanes with trimethylsilyl end groups having preferably 0 to 6 dimethylsiloxane units, or cyclic dimethylpolysiloxanes having preferably 4 to 7 dimethylsiloxane units, for example hexamethyldisiloxane, octamethyltrisiloxane, octamethylcyclotetrasiloxane and decamethylcyclopentasiloxane;

ketones, such as acetone, methyl ethyl ketone, diisopropyl ketone, methyl isobutyl ketone (MIBK); esters, such as ethyl acetate, butyl acetate, propyl propionate, ethyl butyrate, ethyl isobutyrate; carbon disulfide and nitrobenzene, or mixtures of these solvents.

The term “solvent” does not mean that all reaction components must dissolve therein. The reaction may also be performed in a suspension or emulsion of one or more reactants. The reaction may also be performed in a solvent mixture with a miscibility gap, at least one reactant in each case being soluble in each of the mixed phases.

Particularly preferably, a solution of trifluoromethanesulfonic acid and the initiator is used, with methylene chloride being used as preferred solvent.

The amount of catalyst and initiator used determines the achievable molecular weight of the 1,3-dioxolane copolymer of the general formula I.

The alcohol R³OH used as initiator controls the desired chain length of the 1,3-dioxolane copolymers of the general formula (I).

The Lewis or Brønsted acid is used in catalytic amounts to activate the initiator.

The molar ratio of Lewis or Brønsted acid to alcohol of the general formula R³OH is preferably between 0.5 and 0.001, in particular between 0.1 and 0.01.

Preferably 50 to 10 000 mol ppm, particularly preferably 100 to 5000 mol ppm, in particular 200 to 4000 mol ppm of Lewis or Brønsted acid is used per mol of the sum total of 1,3-dioxolane and alkyl-substituted 1,3-dioxolane of the general formula II.

The Lewis or Brønsted acid is preferably mixed with the alcohol of the general formula R³OH before the mixture is added to the 1,3-dioxolane and alkyl-substituted 1,3-dioxolane of the general formula II.

The process is preferably performed at a temperature of between 10° C. and 60° C., particularly preferably between 15° C. and 40° C., in particular between 21° C. and 30° C. A reaction temperature of 23° C. is very particularly preferred.

The reaction is preferably worked up by inactivating the catalyst by means of a suitable base, washing with a hydrocarbon, such as heptane, and drying under reduced pressure.

Suitable bases are preferably pyridine, triethylamine or aqueous sodium hydroxide solution.

The polyacetals may be used as emulsifiers or as reactants for the preparation of functional silicone oils, or similar purposes.

In the examples which follow, unless stated otherwise in each case, all figures for amounts and percentages are based on weight, all pressures are 0.10 MPa (abs.) and all temperatures are 20° C.

### EXAMPLES

### Analysis for the Entire Invention:

NMR spectroscopy to determine the proportion of alkyl ethylene oxide bridges. The measurement is effected in solution in CDCl3 on a Bruker Avance 500 or Ascend 500 (500 MHz for 1H spectrum). All measurements are referenced against TMS as external standard. The relative ratios of the monomer units in the polymer are determined by integrating the respective sets of signals. In addition, the chain length and the molar mass of the polymer can be determined by integrating the end group signals.

SEC (Size-Exclusion Chromatography): to determine the number-average and mass-average molecular weights Mn, Mw and the polydispersity:

The measurement is effected against a polystyrene standard, determined in THF, at 35° C., flow rate 0.3 ml/min and detection with RID (refractive index detector) on an Agilent PLgel MiniMIX-C Guard column with an injection volume of 20 μl.

### Rheometer to Determine the Dynamic Viscosity

The measurement is effected on an Anton Paar MCR 320 rotational viscometer at 25° C. The graphical evaluation is performed by plotting viscosity against shear stress.

DSC (Differential Scanning Calorimetry/Differential Thermal Analysis) to determine the melting point and the glass transition temperature:

The measurements were effected on a Mettler Toledo DSC-1 device in a temperature range of −150° C. to 150° C. in two runs with a heating or cooling rate of 10 K, the second run being used to determine the melting point and the glass transition temperature.

### TGA Analysis to Determine the Start of Decomposition:

The start of decomposition (onset) was determined on a Mettler Toledo TGA-2 device, the sample being heated at a heating rate of 10 K/min in an oxygen atmosphere.

### Example 1

Preparation of the catalyst solution: 10 ml of dry dichloromethane, 1.9 ml of allyloxyethanol and 76 μl of trifluoromethanesulfonic acid are combined and stirred for 1 h at room temperature. 1.35 ml of the previously prepared catalyst solution is placed in a flask and adjusted to a temperature of 23° C. 10.12 g (96 mmol) of 4-ethyl-1,3-dioxolane (EDX) and 6.75 ml (96 mmol) of 1,3-dioxolane (DXL) are then added and stirred.

After 4 h, pyridine is added until the mixture loses its color. The product is washed with heptane and distilled water and then dried under reduced pressure.

### Example 2

2.7 ml of the catalyst solution prepared in Example 1 is placed in a flask and adjusted to a temperature of 23° C. 10.12 g (96 mmol) of 4-ethyl-1,3-dioxolane (EDX) and 6.75 ml (96 mmol) of 1,3-dioxolane (DXL) are then added and stirred.

After 4 h, pyridine is added until the mixture loses its color. The product is washed with heptane and distilled water and then dried under reduced pressure.

### Example 3

5.4 ml of the catalyst solution prepared in Example 1 is placed in a flask and adjusted to a temperature of 23° C. 10.12 g (96 mmol) of 4-ethyl-1,3-dioxolane (EDX) and 6.75 ml (96 mmol) of 1,3-dioxolane (DXL) are then added and stirred.

After 4 h, pyridine is added until the mixture loses its color. The product is washed with heptane and distilled water and then dried under reduced pressure.

### Example 4

Preparation of the catalyst solution: 10 ml of dry dichloromethane, 5.15 g of hydroxypropyl methacrylate and 152 μl of trifluoromethanesulfonic acid are combined and stirred for 1 h at room temperature. 4.05 ml of the previously prepared catalyst solution is placed in a flask and adjusted to a temperature of 23° C. 15.18 g (144 mmol) of 4-ethyl-1,3-dioxolane (EDX) and 10.12 ml (144 mmol) of 1,3-dioxolane (DXL) are then added and stirred.

After 4 h, pyridine is added until the mixture loses its color. The product is washed with heptane and distilled water and then dried under reduced pressure.

### Example 5

Preparation of the catalyst solution: 10 ml of dry dichloromethane, 3.34 g of 1-dodecanol and 76 μl of trifluoromethanesulfonic acid are combined and stirred for 1 h at room temperature. 1.35 ml of the previously prepared catalyst solution is placed in a flask and adjusted to a temperature of 23° C. 10.12 g (96 mmol) of 4-ethyl-1,3-dioxolane (EDX) and 6.75 ml (96 mmol) of 1,3-dioxolane (DXL) are then added and stirred.

After 4 h, pyridine is added until the mixture loses its color. The product is washed with heptane and distilled water and then dried under reduced pressure.

### Example 6

Preparation of the catalyst solution: 10 ml of dry dichloromethane, 1.05 ml of ethanol and 76 μl of trifluoromethanesulfonic acid are combined and stirred for 1 h at room temperature. 1.35 ml of the previously prepared catalyst solution is placed in a flask and adjusted to a temperature of 23° C. 10.12 g (96 mmol) of 4-ethyl-1,3-dioxolane (EDX) and 6.75 ml (96 mmol) of 1,3-dioxolane (DXL) are then added and stirred. After 4 h, pyridine is added until the mixture loses its color. The product is washed with heptane and distilled water and then dried under reduced pressure.

### Example 7 (Non-Inventive)

1.35 ml of the catalyst solution prepared in Example 1 is placed in a flask and adjusted to a temperature of 23° C. 13.5 ml (193 mmol) of 1,3-dioxolane (DXL) is then added and stirred. It is no longer possible to stir the reaction mixture after 10 min. 1 ml of pyridine and 10 ml of dichloromethane are added to the reaction solution. The solids are then precipitated in heptane, washed with distilled water and dried under reduced pressure.

The results of the examples are detailed in Table 1:

TABLE 1

| | | Amount of | M in | Mn in | Mw in | | | |
|---|---|---|---|---|---|---|---|---|
| | | initiator in | g/mol | g/mol | g/mol | | Viscosity | Tg in |
| Example | Initiator | mol % | (NMR) | (SEC) | (SEC) | PDI | in Pas | ° C. |
| 1 | Allyloxyethanol | 1.25 | 4120 | 2750 | 6560 | 2.47 | 5.4 | −64 |
| 2 | Allyloxyethanol | 2.5 | 2810 | 3860 | 6340 | 1.64 | 2.7 | −65 |
| 3 | Allyloxyethanol | 5.0 | 1600 | 1610 | 2700 | 1.67 | 0.87 | −67 |
| 4 | Hydroxybutyl | 5.6 | 1800 | 2010 | 3520 | 1.75 | 1.7 | −62 |
| | methacrylate | | | | | | | |
| 5 | Dodecanol | 1.26 | 4980 | 3510 | 6470 | 1.85 | 4.6 | −64 |
| 6 | Ethanol | 1.26 | 4020 | 4020 | 7300 | 1.82 | 7.3 | −63 |
| 7* | Allyloxyethanol | 1.24 | 4800 | 3720 | 9420 | 2.53 | n.d. | −62 |
| | | | | | | | (product | |
| | | | | | | | is solid) | |

*non-inventive

1-11. (canceled)

12. 1,3-Dioxolane copolymers, comprising:
wherein the 1,3-Dioxolane copolymers have a general formula I 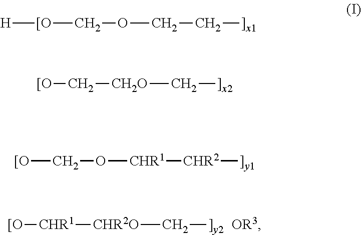
wherein x1+x2 has values of 10 to 2000;
wherein R¹ and R² are hydrogen radicals or C₁ to C₁₈ alkyl radical, wherein in each case at least one radical R¹ or R² in the units [O—CH₂—O—CHR¹—CHR²-]_{y1} and [0-CHR¹—CHR²O—CH₂-]_{y2} is a C₁ to C₁₈ alkyl radical;
wherein y1+y2 has values of 3*(x1+x2+y1+y2)/100 to 50*(x1+x2+y1+y2)/100;
wherein R³ is an aliphatically saturated or unsaturated hydrocarbon radical which is unsubstituted or substituted by halogen atoms, amino groups, C₁₋₆ alkyl, C₁₋₆ alkoxy or silyl groups and has 1 to 100 carbon atoms, in which one or more mutually non-adjacent —CH₂ units may be replaced by —O—, —S—, C═O, —O—C(O)— or —NR⁴— groups and in which one or more mutually non-adjacent ═CH units may be replaced by —N═ groups; and
wherein R⁴ is a hydrogen radical or C₁ to C₁₈ alkyl radical.

13. The 1,3-dioxolane copolymers of claim 12, wherein the radicals R¹ and R² are selected from hydrogen radicals or methyl, ethyl, n-propyl or i-propyl radicals.

14. The 1,3-dioxolane copolymers of claim 12, wherein in each case only one radical R¹ or R² in the units [O—CH₂—O—CHR¹—CHR²-]_{y1} and [O—CHR¹—CHR²O—CH₂-]_{y2} is a C₁ to C₁₈ alkyl radical.

15. The 1,3-dioxolane copolymers of claim 12, wherein the copolymers have a molecular weight Mw of between 750-300 000, measured against a polystyrene standard, in THF, at 35° C., flow rate 0.3 ml/min and detection with RID (refractive index detector) on an Agilent PLgel MiniMIX-C Guard column with an injection volume of 20 μl.

16. The 1,3-dioxolane copolymers of claim 12, wherein the copolymers have a dynamic viscosity at 25° C. of between 50 mPas-500 Pas, measured on an Anton Paar MCR 320 rotational viscometer at 25° C., where the graphical evaluation is performed by plotting viscosity against shear stress.

17. The 1,3-dioxolane copolymers of claim 12, wherein R³ is an alkyl radical having 1 to 18 carbon atoms.

18. The 1,3-dioxolane copolymers of claim 12, wherein R³ is an alkenyl radical having 2 to 10 carbon atoms, in which one or more mutually non-adjacent —CH₂ units may be replaced by —O— or —O—C(O)— groups.

19. A process for producing 1,3-dioxolane copolymers, comprising:
providing 1,3-dioxolane copolymers having the general formula I 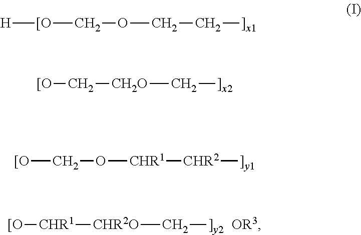
wherein x1+x2 has values of 10 to 2000,
wherein R¹ and R² are hydrogen radicals or C₁ to C₁₈ alkyl radical, where in each case at least one radical R¹ or R² in the units [O—CH₂—O—CHR¹—CHR²-]_{y1} and [O—CHR¹—CHR²O—CH₂-]_{y2} is a C₁ to C₁₈ alkyl radical,
wherein y1+y2 has values of 3*(x1+x2+y1+y2)/100 to 50*(x1+x2+y1+y2)/100,
wherein R³ is an aliphatically saturated or unsaturated hydrocarbon radical which is unsubstituted or substituted by halogen atoms, amino groups, C₁₋₆ alkyl, C₁₋₆ alkoxy or silyl groups and has 1 to 100 carbon atoms, in which one or more mutually non-adjacent —CH₂ units may be replaced by —O—, —S—, C═O, —O—C(O)— or —NR⁴— groups and in which one or more mutually non-adjacent=CH units may be replaced by —N═ groups, and
wherein R⁴ is a hydrogen radical or C₁ to C₁₈ alkyl radical; and
copolymerizing the 1,3-dioxolane copolymers with an alkyl-substituted 1,3-dioxolane of the general formula II 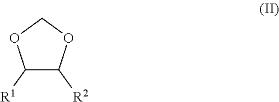
in the presence of a Lewis or Brønsted acid and an alcohol of the general formula R³OH, where the molar ratio of Lewis or Brønsted acid to alcohol of the general formula R³OH is less than 1.

20. The process of claim 19, wherein the acid is trifluoromethanesulfonic acid.

21. The process of claim 19, wherein 50 to 10 000 mol ppm of Lewis or Brønsted acid is used per mol of the sum total of 1,3-dioxolane and alkyl-substituted 1,3-dioxolane of the general formula II.

22. The process of claim 19, wherein the temperature is between 10° C. and 60° C.
